(19) United States
(12) Patent Application Publication
(10) Pub. No.: US 2026/0097806 A1
(43) Pub. Date: Apr. 9, 2026

(54) VEHICLE STEERING APPARATUS AND VEHICLE INCLUDING THE SAME

(71) Applicant: HL MANDO CORPORATION, Pyeongtaek-si (KR)

(72) Inventor: Kyungseok HWANGBO, Pyeongtaek-si (KR)

(21) Appl. No.: 19/323,476

(22) Filed: Sep. 9, 2025

(30) Foreign Application Priority Data
Oct. 7, 2024 (KR) 10-2024-0135500
Jun. 11, 2025 (KR) 10-2025-0076024

(51) Int. Cl. B62D 5/04

(52) U.S. Cl. CPC B62D 5/0448; B62D 5/0421; B62D 5/046

(57) ABSTRACT

The present embodiments may provide a vehicle steering apparatus and a vehicle including the same, the vehicle steering apparatus including first and second housings coupled in an axial direction and configured to accommodate a ball nut coupled to a rack bar by a ball, a bearing configured to be coupled between the ball nut and the first housing, and a bearing support member coupled to an outer race of the bearing and supported on an inner peripheral surface of the first housing.

### CROSS-REFERENCE TO RELATED APPLICATIONS

This application claims the priority of Korean Patent Application No. 10-2024-0135500 filed on Oct. 7, 2024, in the Korean Intellectual Property Office, and Korean Patent Application No. 10-2025-0076024 filed on Jun. 11, 2025, in the Korean Intellectual Property Office, which are incorporated herein by reference in their entireties.

### BACKGROUND

### Field

The present embodiments relate to a vehicle steering apparatus and a vehicle including the same.

### Description of the Related Art

In general, power steering has been developed and applied to a vehicle steering apparatus to provide convenience in a driving operation by assisting an operating force applied to a steering wheel by a driver. Hydraulic power steering using hydraulic pressure, electrohydraulic power steering using hydraulic pressure and power of a motor, and electric power steering using only power of a motor have been developed and applied as the power steering.

However, after durability of the vehicle steering apparatus deteriorates, operational noise, vibration, rattle noise, and the like occur between a ball nut, a bearing, and a housing.

In particular, because the bearing, which supports the ball nut that is coupled to a rack bar and rotates, consistently receives loads applied to the rack bar in an axial direction and a radial direction, there is a problem in that various types of noise and vibration occur as durability deteriorates.

Further, for this reason, there is a problem in that an accurate steering force cannot be transmitted, noise and vibration occur, and a belt is damaged.

Therefore, there is a need for a vehicle steering apparatus capable of transmitting an accurate steering force and ensuring vehicle driving safety while preventing operational noise, vibration, and rattle noise from occurring between a ball nut, a bearing, and a housing even after durability deteriorates.

### SUMMARY

Accordingly, the present embodiments have been made keeping in mind the above-mentioned background, and the present embodiments may provide a vehicle steering apparatus capable of transmitting an accurate steering force and ensuring vehicle driving safety while preventing operational noise, vibration, and rattle noise from occurring between a ball nut, a bearing, and a housing even after durability deteriorates.

In addition, the objects of the present embodiments are not limited thereto, and other objects, which are not mentioned above, may be clearly understood by those skilled in the art from the following descriptions.

The present embodiments may provide a vehicle steering apparatus including first and second housings coupled in an axial direction and configured to accommodate a ball nut coupled to a rack bar by a ball, a bearing configured to be coupled between the ball nut and the first housing, and a bearing support member coupled to an outer race of the bearing and supported on an inner peripheral surface of the first housing.

In addition, the present embodiments may provide a vehicle including: first and second housings coupled in an axial direction and configured to accommodate a ball nut coupled to a rack bar by a ball; a bearing configured to be coupled between the ball nut and the first housing; a first support member including a first outer peripheral support portion configured to support an outer peripheral surface of the outer race, and a first lateral end support portion extending inward in a radial direction from the first outer peripheral support portion and configured to support one end of the outer race; a second support member including a second outer peripheral support portion configured to support the outer peripheral surface of the outer race, and a second lateral end support portion extending inward in the radial direction from the second outer peripheral support portion and configured to support the other end of the outer race; a first elastic member coupled between the first end of the outer race and the first lateral end support portion; and a second elastic member coupled between the second end of the outer race and the second lateral end support portion and configured to be elastically deformed in the axial direction.

In addition, the present embodiments may provide a vehicle including: first and second housings coupled in an axial direction and configured to accommodate a ball nut coupled to a rack bar by a ball; a bearing configured to be coupled between the ball nut and the first housing; a first support member including a first outer peripheral support portion configured to support an outer peripheral surface of the outer race, and a first lateral end support portion bent from the first outer peripheral support portion and configured to support one end of the outer race; a second support member including a second outer peripheral support portion configured to support the outer peripheral surface of the outer race, and a second lateral end support portion extending inward in the radial direction from the second outer peripheral support portion and configured to support the other end of the outer race; a nut pulley coupled to the ball nut; a motor pulley coupled to a shaft of a motor; a driving belt configured to connect the nut pulley and the motor pulley and transmit driving power of the motor; and an electronic control device configured to control the driving power of the motor based on an electrical signal generated from a torque sensor.

According to the present embodiments described above, it is possible to transmit an accurate steering force and ensure vehicle driving safety while preventing operational noise, vibration, and rattle noise from occurring between the ball nut, the bearing, and the housing even after durability deteriorates.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view illustrating a part of a vehicle steering apparatus according to the present embodiments;

FIG. 2 is an exploded perspective view illustrating a part of the vehicle steering apparatus according to the present embodiments;

FIG. 3 is a front view illustrating a part of the vehicle steering apparatus according to the present embodiments;

FIG. 4 is a perspective view illustrating a part of the vehicle steering apparatus according to the present embodiments;

FIG. 5 is an exploded perspective view illustrating a part of the vehicle steering apparatus according to the present embodiments;

FIG. 6 is a cross-sectional view illustrating a part of the vehicle steering apparatus according to the present embodiments;

FIG. 7 is an exploded perspective view illustrating a part of the vehicle steering apparatus according to the present embodiments; and

FIG. 8 is a schematic view illustrating a vehicle according to the present embodiments.

### DETAILED DESCRIPTION OF THE EMBODIMENT

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

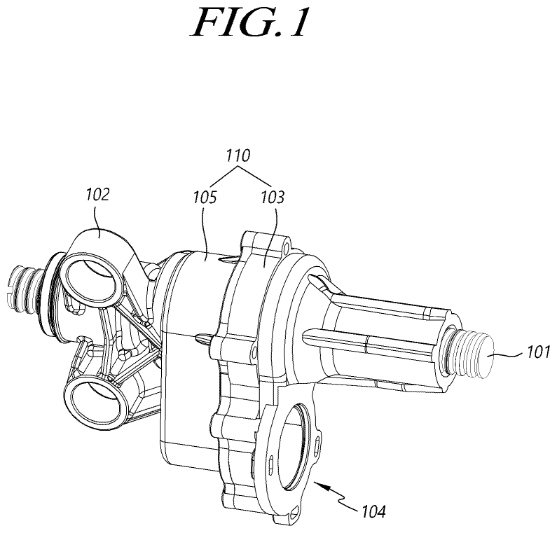

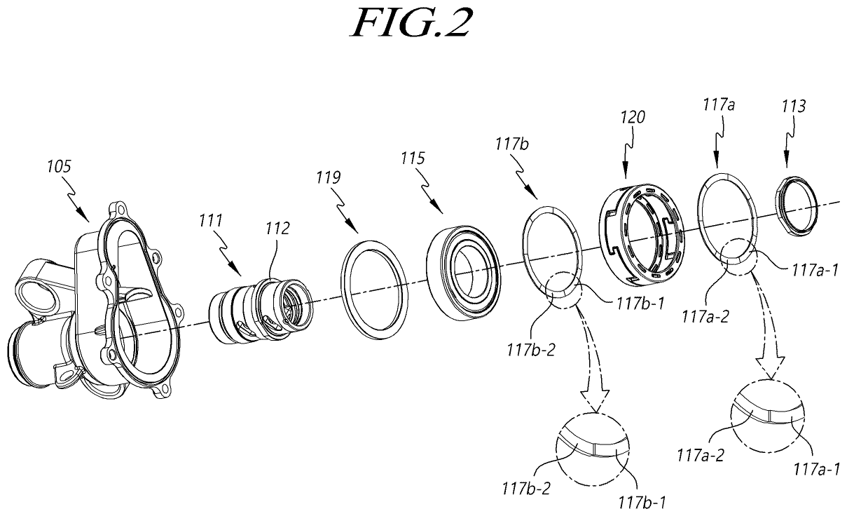

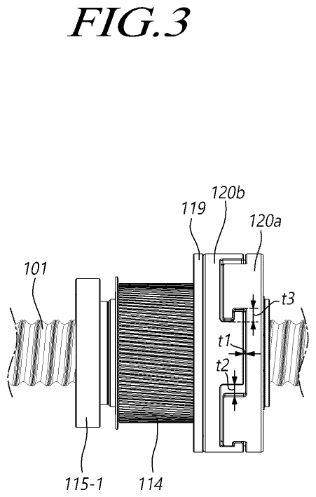

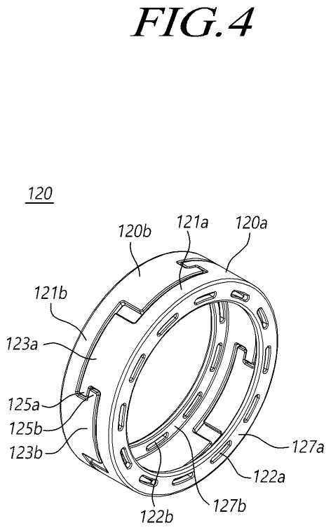

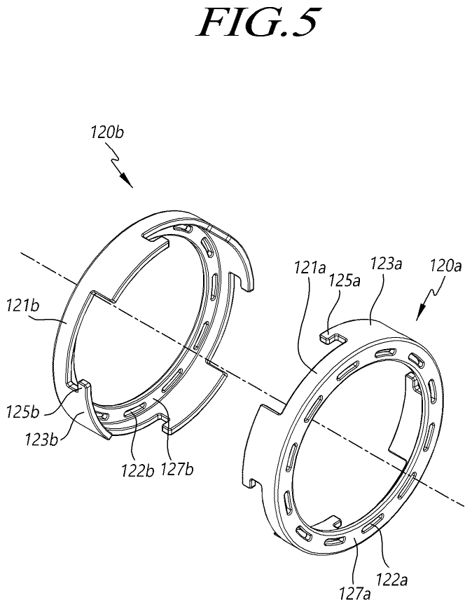

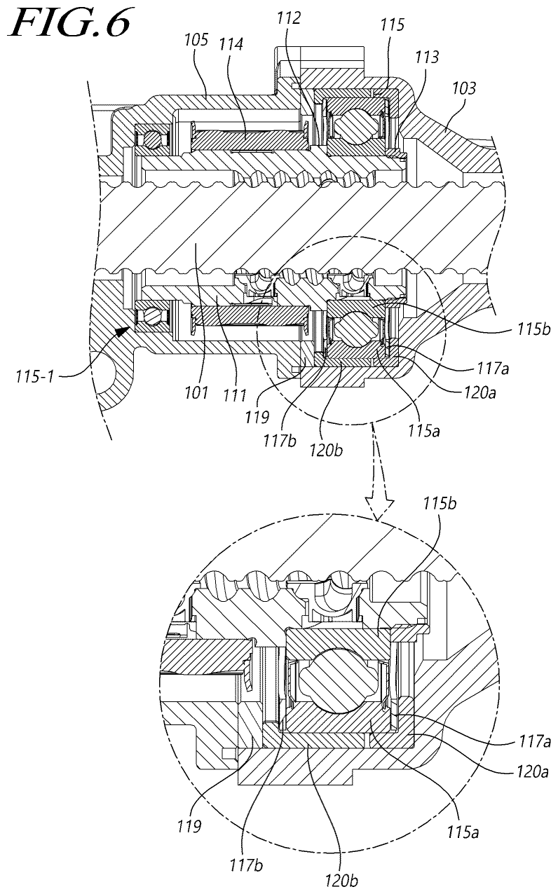

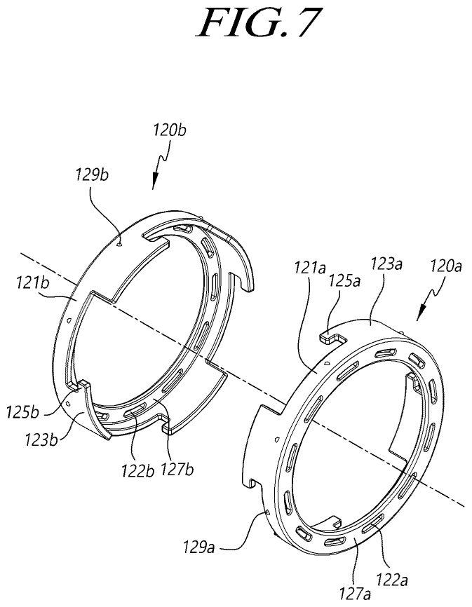

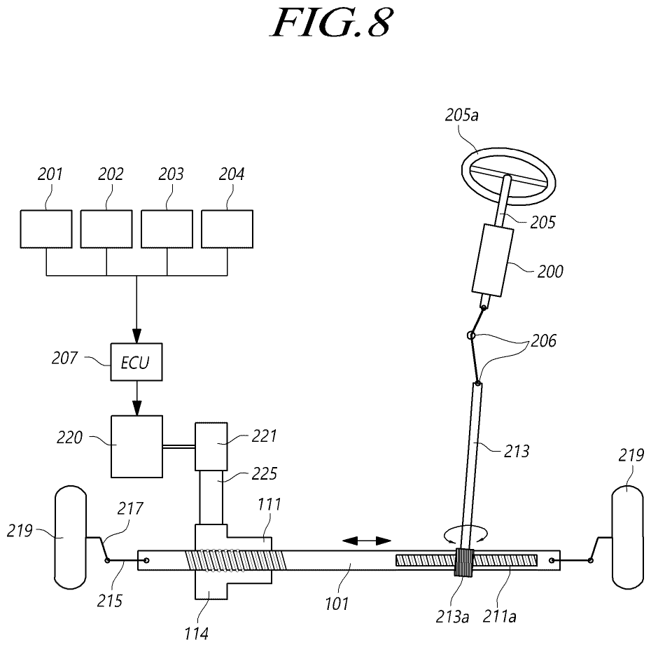

FIG. 1 is a perspective view illustrating a part of a vehicle steering apparatus according to the present embodiments, FIG. 2 is an exploded perspective view illustrating a part of the vehicle steering apparatus according to the present embodiments, FIG. 3 is a front view illustrating a part of the vehicle steering apparatus according to the present embodiments, FIG. 4 is a perspective view illustrating a part of the vehicle steering apparatus according to the present embodiments, FIG. 5 is an exploded perspective view illustrating a part of the vehicle steering apparatus according to the present embodiments, FIG. 6 is a cross-sectional view illustrating a part of the vehicle steering apparatus according to the present embodiments, FIG. 7 is an exploded perspective view illustrating a part of the vehicle steering apparatus according to the present embodiments, and FIG. 8 is a schematic view illustrating a vehicle according to the present embodiments.

As illustrated in these drawings, the vehicle steering apparatus according to the present embodiments includes first and second housings 103 and 105 coupled in an axial direction and configured to accommodate a ball nut 111 connected to a rack bar 101 by a ball (not illustrated), a bearing 115 coupled between the ball nut 111 and the first housing 103, and a bearing support member 120 coupled to an outer race 115a of the bearing 115 and supported on an inner peripheral surface of the first housing 103.

The vehicle steering apparatus according to the present embodiments is provided with a driving means and a driven means that assist a steering force. The driving means includes a motor 220 configured to be controlled by an electronic control device, and a motor pulley 221 coupled to a motor shaft and configured to transmit driving power of the motor 220 to a nut pulley 114 by a driving belt 225.

The driving belt is coupled to the motor pulley 221 and the nut pulley 114 and transmits a rotational force of the motor 220 to the nut pulley 114.

In addition, the driven means includes the ball nut 111 coupled to the rack bar 101 in the first and second housings 103 and 105 in which the rack bar 101 is embedded, and the nut pulley 114 coupled to an outer peripheral surface of the ball nut 111.

A central axis of the motor pulley 221, which is coupled to the motor shaft, and a central axis of the nut pulley 114, which is coupled to the ball nut 111, are disposed in parallel with each other. The driving belt 225 is coupled to the motor pulley 221 and the nut pulley 114 and transmits a rotational force of the motor 220 to the rack bar 101 through the ball nut 111, and the rack bar 101 is moved leftward and rightward by an operation of the ball nut 111, thereby generating steering assistive power.

The first and second housings 103 and 105, which accommodate the rack bar 101 and the ball nut 111, are coupled in the axial direction, and the first housing 103 has a motor coupling portion 104 to which the motor 220 is coupled.

A coupling protrusion 112, which protrudes in a radial direction, is formed in a circumferential direction on the outer peripheral surface of the ball nut 111, an inner race 115b of the bearing 115 is supported on and coupled to one side of the coupling protrusion 112 in the axial direction, and the nut pulley 114 is supported on and coupled to the other side of the coupling protrusion 112 in the axial direction.

The bearing 115 is coupled between the ball nut 111 and the first housing 103, and a bearing 115-1 is coupled between the ball nut 111 and the second housing 105.

The ball nut 111 is coupled to the rack bar 101 by the ball (not illustrated) and slides the rack bar 101 in the axial direction in the first and second housings 103 and 105 while rotating.

The nut pulley 114 configured to rotate the ball nut 111 may be mounted on the outer peripheral surface of the ball nut 111 and move the rack bar 101 leftward and rightward, thereby generating the steering assistive power.

As described above, the nut pulley 114 configured to rotate the ball nut 111 rotates in conjunction with the motor pulley 221 by the driving belt 225. After durability deteriorates, operational noise, vibration, rattle noise, and the like occur between the ball nut 111, the bearing 115, and the first and second housings 103 and 105.

In particular, the bearing 115, which supports the ball nut 111 that is coupled to the rack bar 101 and rotates, consistently receives loads applied to the rack bar 101 in the axial direction and the radial direction, which increases a likelihood that problems of various types of noise and vibration occur as durability deteriorates.

Therefore, in the present disclosure, the bearing support member 120 is coupled to the outer race 115a of the bearing 115 to prevent noise and vibration while being supported on an inner peripheral surface of the first housing 103.

The bearing support member 120 may include a first support member 120a coupled to surround a first portion of an outer peripheral surface of the outer race 115a and one end of the outer race 115a, and a second support member 120b coupled to surround a second portion of the outer peripheral surface of the outer race 115a and the other end of the outer race 115a.

The first support member 120a may include a first outer peripheral support portion 121a configured to support the outer peripheral surface of the outer race 115a, and a first lateral end support portion 127a bent from the first outer peripheral support portion 121a and configured to support one end of the outer race 115a.

The second support member 120b may include a second outer peripheral support portion 121b configured to support the outer peripheral surface of the outer race 115a, and a second lateral end support portion 127b extending inward in the radial direction from the second outer peripheral support portion 121b and configured to support the other end of the outer race 115a.

Slots 122a and 122b may be formed through at least any one of the first support member 120a or the second support member 120b in the axial direction.

That is, the slots 122a and 122b may be formed through any one of the first lateral end support portion 127a or the second lateral end support portion 127b in the axial direction, thereby efficiently dispersing vibrational energy transferred to the bearing 115 through the rack bar 101 and the ball nut 111.

The slots 122a and 122b may each be provided as one or more slots. In the present embodiments, an example is described in which the plurality of slots 122a and 122b are respectively provided in the first lateral end support portion 127a and the second lateral end support portion 127b and spaced apart from one another in the circumferential direction.

In addition, as illustrated in FIG. 7, support protrusions 129a and 129b may be provided on at least any one of the first support member 120a or the second support member 120b, and the support protrusions 129a and 129b may protrude in the radial direction and be supported on the inner peripheral surface of the first housing 103.

That is, the support protrusions 129a and 129b may be provided on any one of the first outer peripheral support portion 121a or the second outer peripheral support portion 121b, protrude from an outer peripheral surface of the first outer peripheral support portion 121a or the second outer peripheral support portion 121b, and be supported on the inner peripheral surface of the first housing 103.

The support protrusions 129a and 129b may absorb assembling tolerances as the support protrusions 129a and 129b are elastically deformed in the radial direction when the first support member 120a and the second support member 120b are coupled to the bearing 115-1 and then assembled to the first housing 103.

In addition, the support protrusions 129a and 129b absorb loads applied to the rack bar 101 in the axial direction and the radial direction, thereby preventing noise and vibration.

The support protrusions 129a and 129b may each be provided as one or more support protrusions. In the present embodiments, an example is described in which the plurality of support protrusions 129a and 129b are provided to be spaced apart from one another in the circumferential direction.

The first support member 120a and the second support member 120b are formed in the same shape and symmetrically coupled in the axial direction.

The first outer peripheral support portion 121a may include first extension support portions 123a extending in the axial direction toward the second outer peripheral support portion 121b, and the second outer peripheral support portion 121b may include second extension support portions 123b extending in the axial direction toward the first outer peripheral support portion 121a and disposed adjacent to the first extension support portion 123a in a circumferential direction.

In addition, a gap t1 may be provided between an end of the first extension support portion 123a and an end of the second outer peripheral support portion 121b as the end of the first extension support portion 123a and the end of the second outer peripheral support portion 121b face each other and are spaced apart from each other by the gap t1 in the axial direction, and a gap t1 may also be provided between an end of the second extension support portion 123b and an end of the first outer peripheral support portion 121a as the end of the second extension support portion 123b and the end of the first outer peripheral support portion 121a face each other and are spaced apart from each other by the gap t1 in the axial direction.

The gap t1 between the end of the first extension support portion 123a and the end of the second outer peripheral support portion 121b may be equal to the gap t1 between the end of the second extension support portion 123b and the end of the first outer peripheral support portion 121a.

The first extension support portions 123a may be provided as two or more first extension support portions 123a disposed to be spaced apart from one another in the circumferential direction, and the second extension support portions 123b may also be provided as two or more second extension support portions 123b and disposed alternately with the first extension support portions 123a in the circumferential direction.

In the present embodiments, an example is described in which four first extension support portions 123a and four second extension support portions 123b are formed and disposed to be spaced apart from one another in the circumferential direction.

The first extension support portion 123a may include a first protruding support portion 125a protruding in the circumferential direction from an end of the first extension support portion 123a toward the second extension support portion 123b.

Further, the second extension support portion 123b may include a second protruding support portion 125b protruding in the circumferential direction from an end of the second extension support portion 123b toward the first extension support portion 123a and the second protruding support portion 125b is disposed adjacent to the first protruding support portion 125a in the axial direction.

That is, the first protruding support portion 125a and the second protruding support portion 125b protrude in opposite circumferential directions and are disposed adjacent to each other in the axial direction, such that the first protruding support portion 125a and the second protruding support portion 125b are coupled to engage with each other.

An assembling gap t2 may be provided between the first extension support portion 123a and the second extension support portion 123b as the first extension support portion 123a and the second extension support portion 123b are spaced apart from each other by the assembling gap t2 in the circumferential direction.

A circumferential protrusion degree t3 of each of the first protruding support portion 125a and the second protruding support portion 125b may be smaller than the assembling gap t2 between the first extension support portion 123a and the second extension support portion 123b.

Therefore, in order to couple the first support member 120a and the second support member 120b to the bearing 115, the first extension support portions 123a and the second extension support portions 123b are disposed in a staggered manner in the circumferential direction and moved in the axial direction, and then the first support member 120a or the second support member 120b is rotated in the circumferential direction, such that the first protruding support portions 125a and the second protruding support portions 125b may be coupled adjacent to one another in the axial direction while engaging with one another.

The above-mentioned bearing support member 120 may be made of one or more materials selected from a group consisting of natural rubber (NR), nitrile butadiene rubber (NBR), chloroprene rubber (CR), ethylene propylene diene monomer (EPDM), fluoro-rubber (FPM), styrene butadiene rubber (SBR), chlorosulphonated polyethylene (CSM), urethane, and silicone.

In addition, the bearing support member 120 may be made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

A first elastic member 117a, which is configured to be elastically deformed in the axial direction, may be coupled between one end of the outer race 115a of the bearing 115 and the first lateral end support portion 127a, and a second elastic member 117b, which is configured to be elastically deformed in the axial direction, may be coupled between the other end of the outer race 115a and the second lateral end support portion 127b.

The elastic members 117a and 117b may each be formed in a ring shape. Convex portions 117a-1 and 117b-1, which are convexly formed in the axial direction, and concave portions 117a-2 and 117b-2, which are concavely formed in the axial direction, may be connected in the circumferential direction.

A support ring 119 of an elastic material may be coupled between the second housing 105 and the second support member 120b in the axial direction.

The support ring 119 may be elastically compressed and coupled between the second housing 105 and the second support member 120b and supports the second support member 120b in the axial direction.

A position of the bearing 115, which is coupled to the ball nut 111, the bearing support member 120, the first housing 103, and the second housing 105, as described above, may be fixed as a locking nut 113 is screw-coupled to the ball nut 111 while supporting the inner race 115b of the bearing 115 in the axial direction.

Meanwhile, with reference to FIG. 8 together with FIGS. 1 to 7, a vehicle according to the present embodiments may include the first and second housings 103 and 105 coupled in the axial direction and configured to accommodate the ball nut 111 coupled to the rack bar 101 by the ball, the bearing 115 coupled between the ball nut 111 and the first housing 103, the first support member 120a including the first outer peripheral support portion 121a configured to support the outer peripheral surface of the outer race 115a, and the first lateral end support portion 127a bent from the first outer peripheral support portion 121a and configured to support one end of the outer race 115a, the second support member 120b including the second outer peripheral support portion 121b configured to support the outer peripheral surface of the outer race 115a, and the second lateral end support portion 127b extending inward in the radial direction from the second outer peripheral support portion 121b and configured to support the other end of the outer race 115a, and the elastic members 117a and 117b coupled between one end of the outer race 115a and the first lateral end support portion 127a and between the other end of the outer race 115a and the second lateral end support portion 127b and configured to be elastically deformed in the axial direction.

In this case, because the first and second housings 103 and 105, the bearing 115, the first support member 120a, the second support member 120b, and the elastic members 117a and 117b are identical to those described with reference to FIGS. 1 to 6, a detailed description will be omitted.

In addition, a vehicle according to the present embodiments may include the first and second housings 103 and 105 coupled in the axial direction and configured to accommodate the ball nut 111 coupled to the rack bar 101 by the ball, the bearing 115 coupled between the ball nut 111 and the first housing 103, the first support member 120a including the first outer peripheral support portion 121a configured to support the outer peripheral surface of the outer race 115a, and the first lateral end support portion 127a bent from the first outer peripheral support portion 121a and configured to support one end of the outer race 115a, the second support member 120b including the second outer peripheral support portion 121b configured to support the outer peripheral surface of the outer race 115a, and the second lateral end support portion 127b extending inward in the radial direction from the second outer peripheral support portion 121b and configured to support the other end of the outer race 115a, the nut pulley 114 coupled to the ball nut 111, the motor pulley 221 coupled to a shaft of the motor 220, the driving belt 225 configured to connect the nut pulley 114 and the motor pulley 221 and configured to transmit driving power of the motor 220, and an electronic control device 207 configured to control the driving power of the motor 220 based on an electrical signal generated from a torque sensor 202.

As illustrated in FIG. 8, the vehicle according to the present embodiments is provided with a rack-driving type power-assisted steering system. The torque sensor 202 and an angle sensor 202 may be provided at one side of a steering shaft 205 connected to a steering wheel 205a and detect a manipulation when the driver manipulates the steering wheel 205a. Electrical signals are transmitted from a vehicle speed sensor 203, a wheel rotation angle sensor 204, and the like to the motor 220, thereby steering two opposite wheels 219 by a tie rod 215.

In the present embodiments, the steering shaft 205 at an upper end is connected to a pinion shaft 213 at a lower end by a universal joint 206, and the steering is performed by a rack-pinion mechanism including a pinion 213a and a rack gear 101a.

In this case, driving power of the motor 220 operated by the electronic control device 207 is transmitted to the ball nut 111 through a driving belt 250. The rack bar 101, which is coupled to the ball nut 111 by the ball, slides in the axial direction, the tie rods 215 are coupled to two opposite sides of the rack bar 101, and the tie rods 215 are coupled to knuckle arms 217 connected to the wheels 219 to steer the wheels 219.

The motor pulley 221, which is connected to the shaft of the motor 220, and the nut pulley 114, which is connected to the ball nut 111, are disposed in parallel with each other. The driving belt 250 is coupled to the motor pulley 221 and the nut pulley 114 and transmits a rotational force of the motor 220 to the rack bar 101 through the ball nut 111, and the rack bar 101 is moved leftward or rightward by the operation of the ball nut 111, thereby generating steering assistive power.

Further, the electrical signal generated from the torque sensor 202 is sent to the electronic control device 207. The electronic control device 207 controls the motor 220 based on the electrical signals transmitted from the torque sensor 202 and the electrical signals transmitted from the vehicle speed sensor 203, the wheel rotation angle sensor 204, and the like mounted in the vehicle.

However, for convenience of description, FIG. 12 illustrates an example in which an angle sensor 201, the torque sensor 202, the vehicle speed sensor 203 for transferring steering information to the electronic control device 207, and the wheel rotation angle sensor 204 are provided. However, a motor position sensor, various types of radar and lidar, image sensors, such as a camera, and the like may be provided, and a detailed description thereof will be omitted. According to the present embodiments described above, it is possible to transmit an accurate steering force and ensure vehicle driving safety while preventing operational noise, vibration, and rattle noise from occurring between the ball nut, the bearing, and the housing even after durability deteriorates.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed is:

1. A vehicle steering apparatus, comprising:
first and second housings coupled in an axial direction and configured to accommodate a ball nut coupled to a rack bar by a ball;
a bearing configured to be coupled between the ball nut and the first housing; and
a bearing support member coupled to an outer race of the bearing and supported on an inner peripheral surface of the first housing.

2. The vehicle steering apparatus of claim 1, wherein the bearing support member comprises:
a first support member coupled to surround a first portion of an outer peripheral surface of the outer race and a first end of the outer race; and
a second support member coupled to surround a second portion of the outer peripheral surface of the outer race and a second end of the outer race.

3. The vehicle steering apparatus of claim 2, wherein the first support member comprises:
a first outer peripheral support portion configured to support the first portion of the outer peripheral surface of the outer race; and
a first lateral end support portion extending inward in a radial direction from the first outer peripheral support portion, and configured to support the first end of the outer race.

4. The vehicle steering apparatus of claim 3, wherein the second support member comprises:
a second outer peripheral support portion configured to support the second portion of the outer peripheral surface of the outer race; and
a second lateral end support portion extending inward in the radial direction from the second outer peripheral support portion, and configured to support the second end of the outer race.

5. The vehicle steering apparatus of claim 4, wherein
the first outer peripheral support portion comprises a first extension support portion extending in the axial direction toward the second outer peripheral support portion, and
the second outer peripheral support portion comprises a second extension support portion extending in the axial direction toward the first outer peripheral support portion, and disposed adjacent to the first extension support portion in a circumferential direction.

6. The vehicle steering apparatus of claim 5, wherein
an end of the first extension support portion and an end of the second outer peripheral support portion face each other and are spaced apart from each other by a gap in the axial direction.

7. The vehicle steering apparatus of claim 5, wherein
an end of the second extension support portion and an end of the first outer peripheral support portion face each other and are spaced apart from each other by a gap in the axial direction.

8. The vehicle steering apparatus of claim 5, wherein
the first extension support portion comprises a first protruding support portion protruding in the circumferential direction from an end of the first extension support portion toward the second extension support portion.

9. The vehicle steering apparatus of claim 8, wherein
the second extension support portion comprises a second protruding support portion protruding in the circumferential direction from an end of the second extension support portion toward the first extension support portion, and
the second protruding support portion is disposed adjacent to the first protruding support portion in the axial direction.

10. The vehicle steering apparatus of claim 9, wherein
the first extension support portion and the second extension support portion are spaced apart from each other by an assembling gap in the circumferential direction.

11. The vehicle steering apparatus of claim 10, wherein
a circumferential protrusion degree of each of the first protruding support portion and the second protruding support portion is smaller than the assembling gap between the first extension support portion and the second extension support portion.

12. The vehicle steering apparatus of claim 1, wherein
the bearing support member comprises one or more materials selected from the group consisting of natural rubber (NR), nitrile butadiene rubber (NBR), chloroprene rubber (CR), ethylene propylene diene monomer (EPDM), fluororubber (FPM), styrene butadiene rubber (SBR), chlorosulphonated polyethylene (CSM), urethane, silicone, polyacetal (POM), polyamide (PA), polycarbonate (PC), polyimide (PI), polybutylene terephthalate (PBT), polyphenylene sulfide (PPS), and phenol formaldehyde (PF).

13. The vehicle steering apparatus of claim 4, further comprising:
a first elastic member, which is configured to be elastically deformed in the axial direction, and is coupled between the first end of the outer race and the first lateral end support portion.

14. The vehicle steering apparatus of claim 13, further comprising:
a second elastic member, which is configured to be elastically deformed in the axial direction, and is coupled between the second end of the outer race and the second lateral end support portion.

15. The vehicle steering apparatus of claim 14, wherein
at least one of the first elastic member or the second elastic member has a ring shape, in which a convex portion, that is convex in the axial direction, and a concave portion, that is concave in the axial direction, are connected in a circumferential direction.

16. The vehicle steering apparatus of claim 2, further comprising:
a support ring of an elastic material and coupled between the second housing and the second support member in the axial direction.

17. The vehicle steering apparatus of claim 2, further comprising:
a slot extending through at least one of the first support member or the second support member in the axial direction.

18. The vehicle steering apparatus of claim 2, further comprising:
a support protrusion which is provided on at least one of the first support member or the second support member, protrudes in a radial direction, and is supported on the inner peripheral surface of the first housing.

19. A vehicle, comprising:
first and second housings coupled in an axial direction and configured to accommodate a ball nut coupled to a rack bar by a ball;
a bearing configured to be coupled between the ball nut and the first housing;
a first support member comprising:
a first outer peripheral support portion configured to support a first portion of an outer peripheral surface of an outer race of the bearing, and
a first lateral end support portion extending inward in a radial direction from the first outer peripheral support portion, and configured to support a first end of the outer race;
a second support member comprising:
a second outer peripheral support portion configured to support a second portion of the outer peripheral surface of the outer race, and
a second lateral end support portion extending inward in the radial direction from the second outer peripheral support portion, and configured to support a second end of the outer race; and
elastic members coupled between the first end of the outer race and the first lateral end support portion and between the second end of the outer race and the second lateral end support portion, wherein the elastic members are configured to be elastically deformed in the axial direction.

20. A vehicle, comprising:
a rack bar;
a ball nut;
first and second housings coupled in an axial direction to accommodate the ball nut which is coupled to the rack bar by a ball;
a bearing configured to be coupled between the ball nut and the first housing;
a first support member comprising:
a first outer peripheral support portion configured to support a first portion of an outer peripheral surface of an outer race of the bearing, and
a first lateral end support portion extending inward in a radial direction from the first outer peripheral support portion, and configured to support a first end of the outer race;
a second support member comprising:
a second outer peripheral support portion configured to support a second portion of the outer peripheral surface of the outer race, and
a second lateral end support portion extending inward in the radial direction from the second outer peripheral support portion, and configured to support a second end of the outer race;
a motor;
a torque sensor;
a nut pulley coupled to the ball nut;
a motor pulley coupled to a shaft of the motor;
a driving belt connecting the nut pulley and the motor pulley, and configured to transmit driving power of the motor; and
an electronic control device configured to control the driving power of the motor based on an electrical signal generated from the torque sensor.
